(19) United States
(12) Patent Application Publication
(10) Pub. No.: US 2011/0236694 A1
(43) Pub. Date: Sep. 29, 2011

(54) LAYERED STRUCTURE, FIXING MEMBER AND IMAGE FORMING APPARATUS

(75) Inventors: Koichi Matsumoto, Kanagawa (JP); Keiichi Hayashi, Kanagawa (JP)

(73) Assignee: FUJI XEROX CO., LTD., Tokyo (JP)

(21) Appl. No.: 12/869,864

(22) Filed: Aug. 27, 2010

(30) Foreign Application Priority Data
Mar. 26, 2010 (JP) 2010-073354

(51) Int. Cl. B32B 33/00; B32B 9/00

(52) U.S. Cl. 428/447; 428/411.1

(57) ABSTRACT

A layered structure including a base, and an elastic layer and a release layer positioned on the base in this order, the layered structure satisfying at least one of Formula (1): an interlayer peeling force between the elastic layer and the base at a temperature of from 20° C. to 30° C.<a cohesive failure force of the elastic layer at a temperature of from 20° C. to 30° C.; or Formula (2): an interlayer peeling force between the elastic layer and the release layer at a temperature of from 20° C. to 30° C.<a cohesive failure force of the elastic layer at a temperature of from 20° C. to 30° C.

### CROSS-REFERENCE TO RELATED APPLICATION

This application is based on and claims priority under 35 USC 119 from Japanese Patent Application No. 2010-073354 filed Mar. 26, 2010.

### BACKGROUND

1. Technical Field

The present invention relates to a layered structure, a fixing member and an image forming apparatus.

2. Related Art

A layered structure including a base, and an elastic layer and a release layer positioned on the base in this order, is used for an image forming apparatus.

### SUMMARY

According to an aspect of the invention, there is provided a layered structure including a base, and an elastic layer and a release layer positioned on the base in this order, the layered structure satisfying at least one of Formula (1): an interlayer peeling force between the elastic layer and the base at a temperature of from 20° C. to 30° C.<a cohesive failure force of the elastic layer at a temperature of from 20° C. to 30° C.; or Formula (2): an interlayer peeling force between the elastic layer and the release layer at a temperature of from 20° C. to 30° C.<a cohesive failure force of the elastic layer at a temperature of from 20° C. to 30° C.

### BRIEF DESCRIPTION OF THE DRAWINGS

Exemplary embodiments of the present invention will be described in detail based on the following figures, wherein:

FIG. 1A is a schematic diagram showing the layered structure according to an exemplary embodiment of the invention as a cross-sectional view cut in a direction perpendicular to the width direction;

FIG. 1B is a schematic diagram showing the layered structure according to an exemplary embodiment of the invention as a magnified view of the cross-section of the layered structure;

FIG. 2 is a schematic diagram showing an exemplary embodiment of the fixing member according to the present embodiment as a schematic diagram showing a magnified view of the cross-section of the cylindrical member;

FIG. 3 is a schematic diagram showing an example of the image forming apparatus according to an exemplary embodiment of the invention; and

FIG. 4 is a schematic diagram showing an exemplary embodiment of the process cartridge according to the invention.

### DETAILED DESCRIPTION OF THE INVENTION

(Layered Structure)

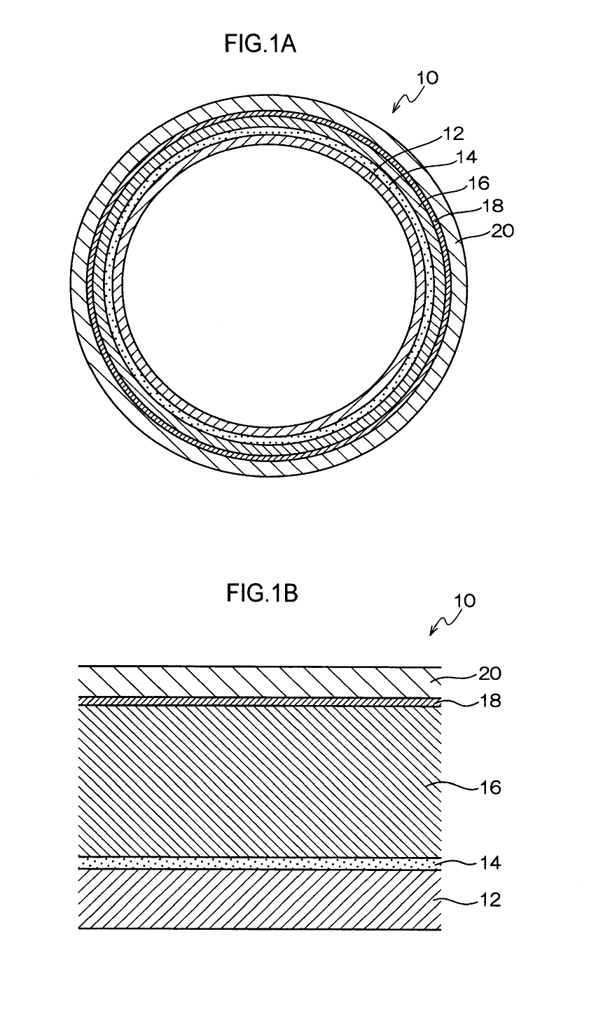

As shown in FIG. 1A and FIG. 1B, the layered structure 10 according to an exemplary embodiment of the invention has a base 12, an elastic layer 16, and a release layer 20 in this order. A first adhesive layer 14 is provided between the base 12 and the elastic layer 16. Further, a second adhesive layer 18 is provided between the elastic layer 16 and the release layer 20.

The layered structure 10 according to an exemplary embodiment of the invention satisfies at least one of the following Formula (1) and the following Formula (2).

Formula (1): an interlayer peeling force between the elastic layer 16 and the base 12 at normal temperature<a cohesive failure force of the elastic layer 16 at normal temperature

Formula (2): an interlayer peeling force between the elastic layer 16 and the release layer 20 at normal temperature<a cohesive failure force of the elastic layer 16 at normal temperature

According to the present embodiment, the normal temperature indicates a temperature in the range of from 20° C. to 30° C.

The interlayer peeling force between the elastic layer 16 and the base 12 can be measured by the following method. Specifically, the interlayer peeling force can be measured under the peeling conditions in which a sample is cut off in a size greater than 15 mm in width and 100 mm in length, a notch is formed between the base and the elastic layer with a cutter blade, and the elastic layer 16 is peeled off at a peeling rate of 5 mm/s in a direction of a peeling angle of 180° with respect to the surface of the base 12. If measurement results at normal temperature are desired, such results may be obtained by carrying out the measurement at normal temperature.

The interlayer peeling force between the elastic layer 16 and the release layer 20 may also be measured by using the same measurement method.

The cohesive failure of the elastic layer 16 indicates a state in which failure (cracks or the like) is occurring inside the elastic layer 16.

This cohesive failure force of the elastic layer 16 is shown by the results of the measurement carried out under the peeling conditions in which a sample is cut off in a size greater than 15 mm in width and 100 mm in length, a notch is formed in the elastic layer with a cutter blade, and the elastic layer 16 is peeled at a peeling rate of 5 mm/s in a direction of a peeling angle of 180° with respect to the surface of the base 12. If measurement results at normal temperature are desired, such results may be obtained by carrying out the measurement at normal temperature.

In the conventional layered structures, although the adhesive strength between the layers that form the layered structure has been enhanced, no attention has been paid concerning separating these layers upon disposal thereof. For this reason, the conventional layered structures are formed in order to satisfy relationships that are opposite to the relationships as defined by the formula (1) and the formula (2) (i.e., the interlayer peeling force is greater than the cohesive failure force at normal temperature) in order to enhance the adhesive force between the layers. In that case, it may be difficult to separate the layers in order to reuse the layered structure upon disposal thereof.

On the other hand, since the layered structure according to an exemplary embdoiment of the invention satisfies at least one of the Formula (1) or the Formula (2), it is thought that the layers of layered structure 10 are easy to be separated upon disposal. Further, since separation of the layers may be easily carried out at the time of disposal, it is thought that the layered structure may be easily reused.

In the layered structure 10 according to an exemplary embodiment of the invention, as shown by the Formula (1), the interlayer peeling force between the elastic layer 16 and the base 12 at normal temperature is preferably smaller than the cohesive failure force of the elastic layer 16 at normal temperature.

In the layered structure 10 according to an exemplary embodiment of the invention, as shown by the Formula (2), the interlayer peeling force between the elastic layer 16 and the release layer 20 at normal temperature is preferably smaller than the cohesive failure force of the elastic layer 16 at normal temperature.

The layered structure 10 according to an exemplary embodiment of the invention satisfies at least one of the Formula (1) or the Formula (2), but it is more preferred to satisfy both the Formula (1) and the Formula (2).

Hereinafter, details of respective layers are described.

(Base)

The base 12 is not particularly limited in terms of its shape, structure, size or the like, and may be selected from those known per se according to the purpose, and used. For example, the base 12 may have a tubular structure.

The base 12 may be formed from an inorganic material, or from a heat resistant resin including an inorganic material. Examples of the inorganic material include metals such as aluminum, SUS, iron, copper and nickel; alloys and ceramics. Examples of the heat resistant resin include polyimide, aromatic polyamide, thermotropic liquid crystal polymer, polyester, polyethylene terephthalate, polyether sulfone, polyether ketone, polysulfone and polyimideamide.

The thickness of the base 12 may be in the range of from 30 μm to 200 μm, in the range of from 40 μm to 150 μm, or in the range of from 50 μm to 130 μm.

The elastic modulus of the base 12 may be in the range of from 100 kgf/mm² to 3000 kgf/mm², or in the range of from 200 kgf/mm² to 2000 kgf/mm², from the viewpoint of achieving both rigidity and flexibility, so that delivery of the layered structure 10 may be repeatedly conducted.

(Elastic Layer)

The material for the elastic layer 16 is not particularly restricted, and examples thereof include a silicone rubber and a fluorine rubber.

The silicone rubber is not particularly limited and may be a one-liquid condensation-polymerization type, a two-liquid addition-polymerization type, or the like. Examples of the silicone rubber include known vinylmethylsilicone rubber, methylsilicone rubber, phenylmethylsilicone rubber, fluorosilicone rubber, and composite materials thereof. Examples of the fluorine rubber include vinylidene fluoride-based rubber, ethylene tetrafluoride/propylene-based rubber, ethylene tetrafluoride/perfluoromethyl vinyl ether rubber, phosphazene-based rubber, fluoropolyether, and other fluorine rubbers. These may be used individually, or as a combination of two or more kinds

Various kinds of additives may be added to the material for the elastic layer 16.

The thickness of the elastic layer 16 may be, for example, in the range of from 50 μm to 5 mm, or from 50 μm to 2 mm.

—Release Layer—

The release layer 20 is provided on the outer surface of the layered structure 10 in order to prevent attachment and fixation of unfixed molten toner during the process of fixation. One example of this release layer 20 is a layer including, as a main component, a low surface energy material such as a fluorine-containing compound.

Examples of the fluorine-containing compound used in the release layer 20 include fluorine resins such as a fluorine rubber, polytetrafluoroethylene (hereinafter, referred to as PTFE), a perfluoroalkyl vinyl ether copolymer (hereinafter, referred to as PFA), and an ethylene tetrafluoride-propylene hexafluoride copolymer (hereinafter, referred to as FEP).

The thickness of the release layer 20 may be in the range of from 1 μm to 100 μm, from 10 μm to 50 μm, or from 20 μm to 50 μm.

—First Adhesive Layer—

The first adhesive layer 14 is a layer having a function of bonding the base 12 and the elastic layer 16. As the adhesive used for this first adhesive layer 14, a material whose adhesive force is changed by hydrolysis or ultraviolet irradiation may be used. One example of the adhesive having such characteristics is a silane coupling agent, such as X33-156-20 (trade name, manufactured by Shin-Etsu Chemical Co., Ltd.), when the base 12 is formed from a polyimide and the elastic layer 16 is formed from a silicone rubber. The adhesive force of this adhesive decreases when hydrolysis is not sufficient.

—Second Adhesive Layer—

The second adhesive layer 18 is a layer having a function of bonding the elastic layer 16 and the release layer 20. One example of the adhesive used for the second adhesive layer 18 is a heat-curable adhesive such as X32-2967 (trade name, manufactured by Shin-Etsu Chemical Co., Ltd.), when a silicone rubber is used as the material for the elastic layer 16 and PFA (tetrafluoroethyelne-perfluoroalkyl vinyl ether copolymer) is used as the material for the release layer 20.

—Method of Producing Layered Structure—

Next, the method of producing the layered structure 10 according to an exemplary embodiment of the invention will be described.

The layered structure 10 according to an exemplary embodiment of the invention may be produced by providing, on the base 12, the first adhesive layer 14, the elastic layer 16, the second adhesive layer 18 and the release layer 20 in this order.

The first adhesive layer 14 or the second adhesive layer 18 may be formed by applying the material for the first adhesive layer 14 or the second adhesive layer 18, or a coating liquid prepared by dissolving the material in a solvent, on the base 12 or the elastic layer 16 by a known coating method, such as a dipping method, a spin method, a spray method or a roll coating method.

The elastic layer 16 is formed by applying the material (uncured) for the elastic layer 16 by a known coating method, and then subjecting the formed film to a heat treatment. The release layer 20 may be formed by covering the layered structure with the release layer 20 having a tubular shape.

It is essential for the layered structure 10 according to an exemplary embodiment of the invention to satisfy at least one of the Formula (1) or the Formula (2).

In order to produce a layered structure 10 that satisfies the formula (1), the first adhesive layer 14, which is a layer disposed between the base 12 and the elastic layer 16, may be formed by applying a coating liquid containing the material for the first adhesive layer 14 on the base 12, while adjusting the hydrolysability of the hydrolysable group in the adhesive contained in the coating liquid, or exposing the coating liquid to ultraviolet radiation, before or after the application of the coating liquid on the base 12.

This hydrolysis treatment may be carried out by, for example, mixing the coating liquid with an aqueous solution containing water and allowing this mixture to stand over a predetermined time or longer. The time or the temperature required in the hydrolysis treatment may vary depending on the type of the adhesive, the concentration thereof, or the like, which may be adjusted so as to satisfy the relationship defined by the Formula (1).

The ultraviolet irradiation treatment may be carried out by using a light source that emits ultraviolet light. The amount of irradiation or the wavelength of ultraviolet rays may also vary depending on the type of the adhesive, the concentration thereof, or the like, which may be adjusted so as to satisfy the relationship defined by the Formula (1).

One example of the method of obtaining the layered structure 10 that satisfies the Formula (2) includes forming the second adhesive layer 18, which is disposed between the elastic layer 16 and the release layer 20, by applying a coating liquid containing the material for the second adhesive layer 18 on the elastic layer 16, and allowing the second adhesive layer 18 to partially cure, and then forming the release layer 20.

The temperature and the time for carrying out the partial curing reaction may be adjusted depending on the type of the material for the second adhesive layer 18 so that the layered structure 10 satisfies the Formula (2).

The method of producing the layered structure 10 that satisfies the Formula (1) or the Formula (2) may be a combination of the adjustment of first adhesive layer 14 and the adjustment of the second adhesive layer 18.

In the following, a fixing member according to an exemplary embodiment of the invention will be explained. In this exemplary embodiment, the layered structure 10 is used as a fixing roll in the fixing member. However, for example, the layered structure 10 may be used as a transfer roll. Moreover, the layered structure 10 may have a belt shape instead of a roll shape.

(Fixing Member)

Next, the fixing member according to an exemplary embodiment of the invention will be described.

The fixing member according to an exemplary embodiment of the invention includes the layered structure 10.

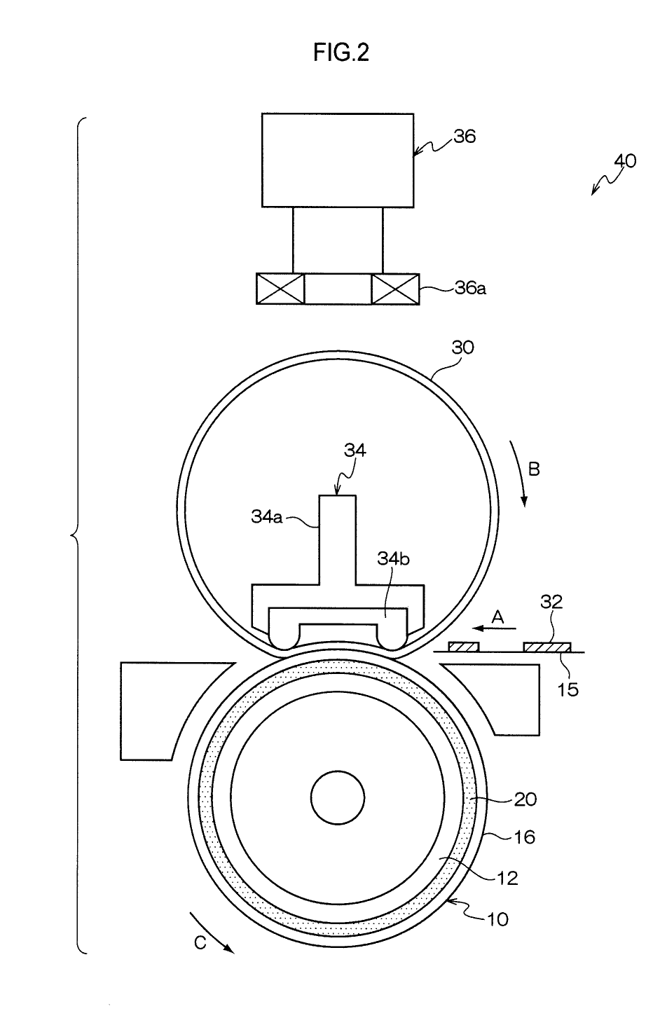

FIG. 2 shows an exemplary structure of the fixing member 40 according to an exemplary embodiment of the invention. As shown in FIG. 2, the fixing member 40 includes the layered structure 10.

As shown in FIG. 2, in the fixing member 40, the layered structure 10 is positioned so as to contact the outer surface of a pressure application member 30, and a contact area is formed between the layered structure 10 and the pressure application member 30. At this contact area, the pressure application member 30 is deformed in accordance with the shape of the surface of the layered structure 10.

The fixing member 40 is also provided with a pressing member 34 that contacts the internal surface of the pressure application member 30 and presses the internal surface of the pressure application member 30 against the layered structure 10. This pressing member 34 can locally increase the pressure applied to the contact area between the pressure application member 30 and the layered structure 10.

This pressing member 34 includes a member 34b and a support 34a that supports the member 34b. The member 34b is made of a metal, a heat resistant resin, a heat resistant rubber or the like, and contacts the internal surface of the pressure application member 30 and applies pressure thereto.

The fixing member 40 is also provided with an electromagnetic induction apparatus 36 that includes an electromagnetic induction coil 36a, at a position opposite to the layered structure 10 via the pressure application member 30.

In the fixing member 40, the layered structure 10 is rotated in a direction of arrow C by a driving apparatus (not shown), and the pressure application member 30 is also rotated in a direction of arrow B along with the rotation of the layered structure 10. A recording medium 15, on which an unfixed toner image 32 is formed, is delivered in a direction of arrow A through the contact area between the pressure application member 30 that is heated by the electromagnetic induction apparatus 36 and the layered structure 10, while being nipped by the pressure application member 30 and the layered structure 10. At the contact area between the pressure application member 30 and the layered structure 10, the unfixed toner image 32 is pressed against the surface of the recording medium 15 in a molten state, and is fixed to the surface of the recording medium 15.

In the vicinity of the outlet portion of the contact area between the pressure application member 30 and the layered structure 10, the pressure application member 30 is freed from the pressure applied by the pressing member 34. As a result, the pressure application member 30 is bent back toward the base layer side with a large curvature, and the shape of the pressure application member 30 is rapidly changed. On the other hand, the recording medium 15 is delivered along the surface of the layered structure 10 while it is conveyed through the contact area between the pressure application member 30 and the layered structure 10. Accordingly, the recording medium 15 is peeled off from the pressure application member 30 by its own rigidity.

Since the fixing member 40 according to an exemplary embodiment of the invention includes the layered structure 10 according to an exemplary embodiment of the invention, the layers of the layered structure 10 may be easily separated at the time of disposing of the same.

(Image Forming Apparatus)

In the following, the layered structure 10 according to an exemplary embodiment of the invention, when it is installed in an image forming apparatus or in a fixing member of a process cartridge, will be described.

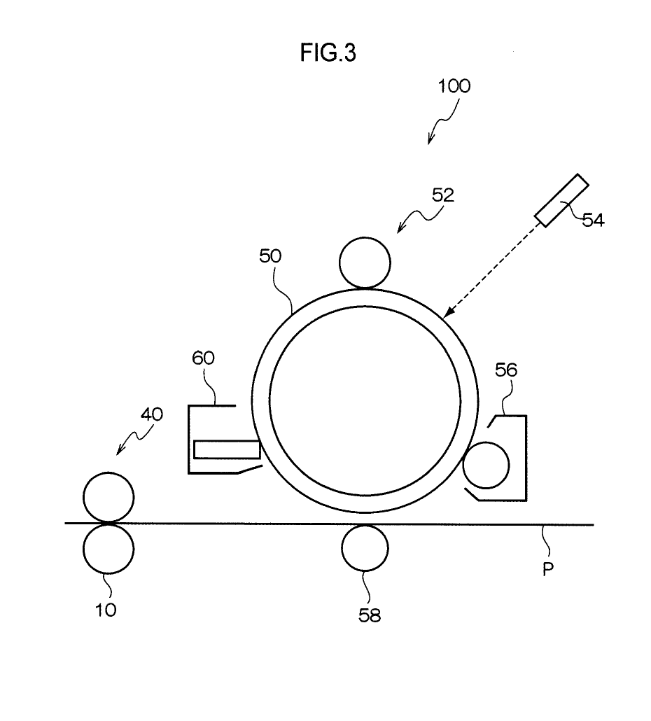

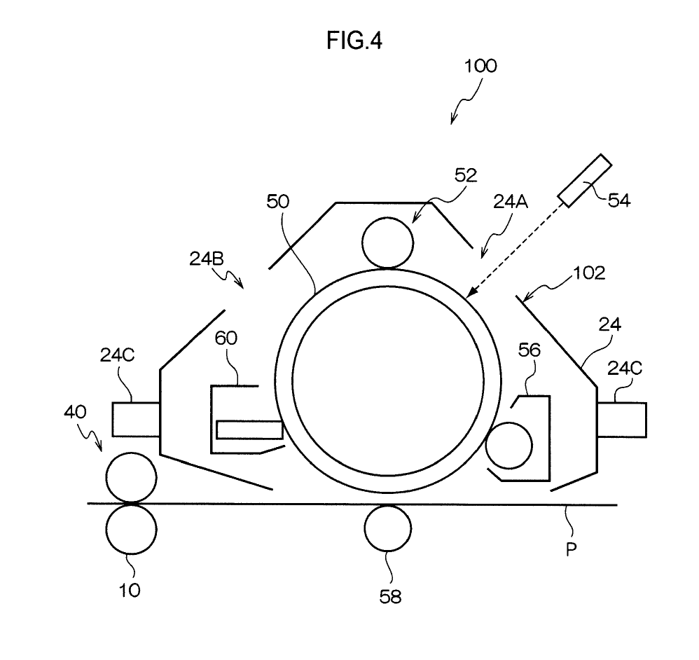

FIG. 3 is a schematic diagram showing an exemplary embodiment of the image forming apparatus according to the invention. FIG. 4 is a schematic diagram showing an exemplary process cartridge according to an exemplary embodiment of the invention.

The image forming apparatus 100 according to the present embodiment includes, as shown in FIG. 3, an image retention body 50. The image forming apparatus also includes, around the image retention body 50, a charging member 52 that charges the image retention body 50; a latent image forming member 54 that forms a latent image by exposing the image retention body 50, which has been charged by the charging member 52, to light; a developing member 56 that forms a toner image with toner by developing an electrostatic latent image formed by the latent image forming member 54; a transfer member 58 that transfers the toner image formed by the developing member 56 to a recording medium P: and a cleaning member 60 that removes toner remaining on the surface of the image retention body 50 after the transfer. The image forming apparatus also includes a fixing member 40 that fixes the toner image transferred to the recording medium P by the transfer member 58.

In the image forming apparatus 100 according to an exemplary embodiment of the invention, the fixing member 40 includes the layered structure 10 according to an exemplary embodiment of the invention.

The components of the image forming apparatus 100 according to an exemplary embodiment of the invention may be selected from known ones used for an electrophotographic image forming apparatus, other than the layered structure 10 installed in the fixing member 40. The following are examples of such components.

The image retention body 50 is not particularly limited, and a known photoreceptor may be used. However, an organic photoreceptor having what is called a function-separated structure, in which a charge generating layer and a charge transport layer are separated, is suitably applied. The latent image forming member 54 may employ a laser optic system, an LED array system, or the like.

The developing member 56 forms a toner image by, for example, contacting the image retention body 50 with a developer retainer having a developer layer formed on its surface, or by approximating the developer retainer to the image retention body 50, thereby attaching toner to the electrostatic latent image formed on the surface of the image retention body 50. The transfer member 58 may employ, for example, a non-contact transfer system such as corotron, or a contact transfer system in which a toner image is transferred on a recording medium P by contacting a conductive transfer roll to the image retention body 50 via the recording medium P.

The cleaning member 60 may be, for example, a plate-shaped member that directly contacts the surface of the image retention body 50 and removes toner, paper dust, dirt or the like that is attached to the surface of the image retention body 50. The cleaning member 60 may be a brush-shaped member or a roll-shaped member, instead of a plate-shaped member.

The image forming apparatus 100 according to an exemplary embodiment of the invention is not limited to those having the structure as described above, and may be, for example, an image forming apparatus employing an intermediate transfer system in which an intermediate transfer body is used, or an image forming apparatus employing what is called a tandem system in which plural image forming units, each forming a toner image of each color, are arranged in parallel.

The process cartridge according to the present embodiment has, as shown in FIG. 4, a structure including, in the image forming apparatus 100 shown in FIG. 3, a casing 24 having an aperture 24A for exposure, an aperture 24B for charge-eliminating exposure, and an attachment rail 24C. The casing 24 integrates a combination of an image retention body 50, a charging member 52 that charges the image retention body 50, a developing member 56 that develops an electrostatic latent image formed by a latent image forming member 54 with toner to form a toner image, and a cleaning member 60 that removes toner remaining on the surface of the image retention body 50 after the transfer. The process cartridge 102 is installed in the image forming apparatus 100 in an attachable and removable manner.

### EXAMPLES

Hereinafter, the invention will be described in more detail based on the examples, but the invention is not limited thereto.

### Example 1

(Production of Layered Structure A1)

A tubular belt made of a polyimide resin (trade name: TX, manufactured by Unitika, Ltd.) having a thickness of 80 μm, an internal diameter of 30 mm, and a length of 400 mm, is used as a base.

On the outer surface of this base, X33-156-20 (manufactured by Shin-Etsu Chemical Co., Ltd.) is applied to form a first adhesive layer having a thickness of approximately 0.1 μm by using a cotton wiper (trade name: BEMCOT, manufactured by Ozu Corporation). Then, the first adhesive layer is allowed to stand for 10 minutes in an environment of 20° C. and 50% RH.

Subsequently, on the first adhesive layer after being stored for 10 minutes, an addition polymerization-type LSR (liquid silicone rubber, trade name: 2086, manufactured by Shin-Etsu Chemical Co., Ltd.) is applied to form an elastic layer having a thickness of 500 μm. The elastic layer is dried for 20 minutes at 110° C., and then dried (cured) for 4 hours at 200° C.

Next, X32-2967 (trade name, manufactured by Shin-Etsu Chemical Co., Ltd.) is applied on the elastic layer to form a second adhesive layer having a thickness of 10 μm. The second adhesive layer is dried for 1 hour at 80° C., at which temperature curing reaction initiates.

Subsequently, the second adhesive layer is covered with a PFA cylindrical tube (thickness: 30 μm), and this is baked at 200° C. so that a release layer is bonded to the second adhesive layer. A layered structure A1 is thus obtained.

—Measurement of Cohesive Failure Force of Elastic Layer at Normal Temperature—

The layered structure A1 is cut off in a size greater than 15 mm in width and 100 mm in length, and the cohesive failure force is measured by forming a notch in the elastic layer with a cutter blade, and peeling off the elastic layer at a peeling rate of 5 mm/s in a direction of a peeling angle of 180° with respect to the surface of the base. The measurement results are shown in Table 1.

—Measurement of Interlayer Peeling Force Between Base and Elastic Layer at Normal Temperature—

The layered structure A1 is cut off in a size greater than 15 mm in width and 100 mm in length, and the interlayer peeling force is measured by forming a notch between the base and the elastic layer with a cutter blade, and peeling off the elastic layer at a peeling rate of 5 mm/s in a direction of a peeling angle of 180° with respect to the surface of the base. The measurement results are shown in Table 1.

—Measurement of Interlayer Peeling Force Between Elastic Layer and Release Layer at Normal Temperature—

The layered structure A1 is cut off in a size greater than 15 mm in width and 100 mm in length, and the interlayer peeling force is measured by forming a notch between the elastic layer and the release layer with a cutter blade, and peeling off the elastic layer at a peeling rate of 5 mm/s in a direction of a peeling angle of 180° with respect to the surface of the base. The measurement results are shown in Table 1.

### Example 2

(Production of layered structure A2)

A layered structure A2 is produced by the same production method and under the same conditions as Example 1, except that the first adhesive layer is formed by applying X33-156-20 (manufactured by Shin-Etsu Chemical Co., Ltd.) and allowing the same to stand for 30 minutes in an environment of 30° C. and 85% RH, and then subjecting the same to ultraviolet irradiation, instead of applying X33-156-20 and alloying the same to stand for 10 minutes in an environment of 20° C. and 50% RH.

The ultraviolet irradiation in Example 2 is carried out under the following conditions.

Specifically, the coating film formed from X33-156-20 (manufactured by Shin-Etsu Chemical Co., Ltd.) on the outer surface of the base as the first adhesive layer is irradiated with light having a wavelength in the region of from 200 nm to 230 nm as ultraviolet rays for 15 minutes, by using a metal halide lamp (ultraviolet irradiation intensity: 240 W/cm) as a UV irradiation apparatus.

The interlayer peeling force between the base and the elastic layer at normal temperature, the interlayer peeling force between the elastic layer and the release layer at normal temperature, and the cohesive failure force of the elastic layer at normal temperature of the layered structure A2 are measured by the same method and under the same conditions as Example 1, respectively. The measurement results are shown in Table 1.

### Example 3

(Production of Layered Structure A3)

A layered structure A3 is produced by the same production method and under the same conditions as Example 2, except that the ultraviolet radiation is performed for 3 minutes after applying X33-156-20 (manufactured by Shin-Etsu Chemical Co., Ltd.) as the first adhesive layer, instead of 15 minutes.

The interlayer peeling force between the base and the elastic layer at normal temperature, the interlayer peeling force between the elastic layer and the release layer at normal temperature, and the cohesive failure force of the elastic layer at normal temperature of the layered structure A3 are measured by the same method and under the same conditions as Example 1, respectively. The measurement results are shown in Table 1.

### Example 4

(Production of Layered Structure A4)

A layered structure A4 is produced by the same production method and under the same conditions as Example 2, except that the ultraviolet irradiation is not performed after applying X33-156-20 (manufactured by Shin-Etsu Chemical Co., Ltd.) as the first adhesive layer.

The interlayer peeling force between the base and the elastic layer at normal temperature, the interlayer peeling force between the elastic layer and the release layer at normal temperature, and the cohesive failure force of the elastic layer at normal temperature were measured by the same method and under the same conditions as Example 1, respectively. The measurement results are shown in Table 1.

### Example 5

(Production of Layered Structure A5)

A layered structure A5 is produced by the same production method and under the same conditions as Example 1, except that the second adhesive layer is dried (cured) at 50° C. for 1 hour, instead of drying the same at 80° C. for 1 hour.

The interlayer peeling force between the base and the elastic layer at normal temperature, the interlayer peeling force between the elastic layer and the release layer at normal temperature, and the cohesive failure force of the elastic layer at normal temperature are measured by the same method and under the same conditions as Example 1, respectively. The measurement results are shown in Table 1.

### Comparative Example 1

(Production of Layered Structure B1)

A layered structure B1 is produced by the same production method and under the same conditions as in Example 2, except that the ultraviolet irradiation is performed for 3 minutes and the second adhesive layer is dried at 50° C. for 1 hour, instead of performing the ultraviolet irradiation for 15 minutes and drying the second adhesive layer at 80° C. for 1 hour.

The interlayer peeling force between the base and the elastic layer at normal temperature, the interlayer peeling force between the elastic layer and the release layer at normal temperature, and the cohesive failure force of the elastic layer at normal temperature of the layered structure B1 are measured by the same method and under the same conditions as Example 1, respectively. The measurement results are shown in Table 1.

—Evaluation of Interlayer Separability—

Interlayer separability of the layered structures produced in Examples 1 to 5 and Comparative Example 1 is evaluated under an environment of normal temperature (25° C.). The evaluation results are shown in Table 1. The evaluation criteria are as follows.

A: Interlayer separation is relatively easy.

B: Interlayer separation is relatively difficult.

C: Interlayer separation is difficult.

TABLE 1

| | Normal temperature | | | | | |
|---|---|---|---|---|---|---|
| | Interlayer | Interlayer | Cohesive | | | |
| | peeling force | peeling force | failure force | | | |
| | between elastic | between elastic | of elastic | | | Evaluation of |
| | layer and base | layer and release | layer | Formula (1) | Formula (2) | interlayer |
| | A (gf) | layer B (gf) | C (gf) | A < C | B < C | separability |
| Example 1 | 160 | 130 | 500 | Satisfied | Satisfied | A |
| Example 2 | 130 | 130 | 500 | Satisfied | Satisfied | A |
| Example 3 | 500 | 130 | 500 | Not satisfied | Satisfied | B |
| Example 4 | 700 | 130 | 500 | Not satisfied | Satisfied | B |
| Example 5 | 160 | 700 | 500 | Satisfied | Not satisfied | B |
| Comparative | 500 | 700 | 500 | Not satisfied | Not satisfied | C |
| Example 1 | | | | | | |

As shown in Table 1, the layered structures produced in the Examples exhibit a higher level of interlayer separability at normal temperature, as compared with the layered structure produced in Comparative Example 1. Therefore, it can be concluded that the layers of the layered structures produced in the Examples can be easily separated at the time of disposing of the same and can be easily reused, as compared with the layered structure produced in Comparative Example 1. Moreover, it is proved that when the interlayer peeling force between the elastic layer and the base at normal temperature is higher than the interlayer peeling force between the elastic layer and the release layer at normal temperature (A>B), interlayer separation between the elastic layer and the release layer occurs primarily upon disposal, whereas when the interlayer peeling force between the elastic layer and the base at normal temperature is lower than the interlayer peeling force between the elastic layer and the release layer at normal temperature (A<B), interlayer separation between the elastic layer and the base occurs primarily upon disposal. In this way, it is possible to obtain a desired state of interlayer separation.

All publications, patent applications, and technical standards mentioned in this specification are herein incorporated by reference to the same extent as if each individual publication, patent application, or technical standard was specifically and individually indicated to be incorporated by reference.

What is claimed is:

1. A layered structure comprising a base, and an elastic layer and a release layer positioned on the base in this order, the layered structure satisfying at least one of Formula (1): an interlayer peeling force between the elastic layer and the base at a temperature of from 20° C. to 30° C.<a cohesive failure force of the elastic layer at a temperature of from 20° C. to 30° C.; or Formula (2): an interlayer peeling force between the elastic layer and the release layer at a temperature of from 20° C. to 30° C.<a cohesive failure force of the elastic layer at a temperature of from 20° C. to 30° C.

2. The layered structure according to claim 1, wherein the elastic layer comprises a silicone rubber or a fluorine rubber.

3. The layered structure according to claim 1, wherein the release layer comprises a fluorine-containing compound.

4. The layered structure according to claim 1, further comprising an adhesive layer between the base and the elastic layer.

5. The layered structure according to claim 1, further comprising an adhesive layer between the elastic layer and the release layer.

6. A layered structure comprising a base, and an elastic layer and a release layer positioned on the base in this order, the layered structure satisfying Formula (1): an interlayer peeling force between the elastic layer and the base at a temperature of from 20° C. to 30° C.<a cohesive failure force of the elastic layer at a temperature of from 20° C. to 30° C.; and
Formula (2): an interlayer peeling force between the elastic layer and the release layer at a temperature of from 20° C. to 30° C.<a cohesive failure force of the elastic layer at a temperature of from 20° C. to 30° C.

7. The layered structure according to claim 6, wherein the elastic layer comprises a silicone rubber or a fluorine rubber.

8. The layered structure according to claim 6, wherein the release layer comprises a fluorine-containing compound.

9. The layered structure according to claim 6, further comprising an adhesive layer between the base and the elastic layer.

10. The layered structure according to claim 6, further comprising an adhesive layer between the elastic layer and the release layer.

11. A fixing member comprising the layered structure according to claim 1.

12. An image forming apparatus comprising the fixing member according to claim 11.
